(19) United States
(12) Patent Application Publication
(10) Pub. No.: US 2014/0031044 A1
(43) Pub. Date: Jan. 30, 2014

(54) HANDOVER MANAGER COMPONENT

(71) Applicant: Nick John Mazzarella, Woodridge, IL (US)

(72) Inventor: Nick John Mazzarella, Woodridge, IL (US)

(21) Appl. No.: 13/556,432

(22) Filed: Jul. 24, 2012

(51) Int. Cl. H04W 36/32

(52) U.S. Cl. 455/440

(57) ABSTRACT

In one implementation of an apparatus, a handover manager component for a communication network is configured to determine a target network element for a handover for a mobile device. The determination is made through employment of an anticipated path of the mobile device and a local geographical profile.

### TECHNICAL FIELD

This application relates generally to handovers in communication networks.

### BACKGROUND

Geographic regions served by wireless communication networks are commonly divided into service coverage areas. The service coverage areas may be served by one or more base stations, which provide an “air interface” to a mobile device of a subscriber to the network. As the mobile device moves through service coverage areas, the base stations and mobile device cooperate to perform a handover between the base stations. For example, as signal strength to a first base station falls below an acceptable threshold, the mobile device is handed over to a second base station that provides better signal strength.

Current handovers between base stations in wireless communication networks use an Automatic Neighbor Relation (ANR) procedures and an ANR database to determine the second base station. The current ANR specification reviews identified neighbor cells in real time as each handover is about to happen. ANR procedures speed up handovers by removing some cells with marginal signal strength as potential neighbors. However, the handover process is still reactive and only responds to each handover as it occurs.

When the ground speed of the mobile device is high, handovers between cells may occur with a high frequency. Each handover uses network resources for determination of the next base station, thus with higher ground speed comes a higher network load. High speed may also cause the mobile device to lose connection with the first base station before it can be handed over to the second base station. This often results in a dropped call or data connection. Speeds associated with dropped calls of this nature are often found with users traveling on high speed rail lines, roadways, or mass-transit routes.

### SUMMARY

The invention in one embodiment encompasses an apparatus. The apparatus comprises a handover manager component for a communication network. The handover manager component is configured to determine a target network element for a handover for a mobile device through employment of an anticipated path of the mobile device and a local geographical profile.

Another implementation of the invention encompasses a method. At least first and second location and timestamp data are compared to create an anticipated path for a mobile device served by a communication network. The anticipated path is compared to a local geographical profile that comprises at least one known transportation route. If the anticipated path matches one of the at least one known transportation routes, a notification of an anticipated handover is sent to one or more network elements of the communication network that are located along the one known transportation route.

### DESCRIPTION OF THE DRAWINGS

Features of example implementations of the invention will become apparent from the description, the claims, and the accompanying drawings in which:

FIG. 1 is a representation of one implementation of an apparatus that comprises a communication network and a mobile device with handovers between radio network controllers and base stations.

FIG. 2 is a representation of a top-down, geographical view of the apparatus of FIG. 1 and illustrates a transportation route with service coverage areas provided by the radio network controllers.

FIG. 3 is another representation of another top-down, geographical view of the apparatus of FIG. 1 and illustrates an alternative transportation route.

FIG. 4 is a representation of the transportation route of FIG. 3 and anticipated paths for the mobile device of FIG. 1.

FIG. 5 is a representation of a geographic approximation of the transportation route of FIG. 3.

FIG. 6 is a representation of a message flow for the apparatus of FIG. 1.

FIG. 7 is a representation of a process flow for the apparatus of FIG. 1.

FIG. 8 is a representation of one implementation of a handover manager component of the apparatus of FIG. 1

### DETAILED DESCRIPTION

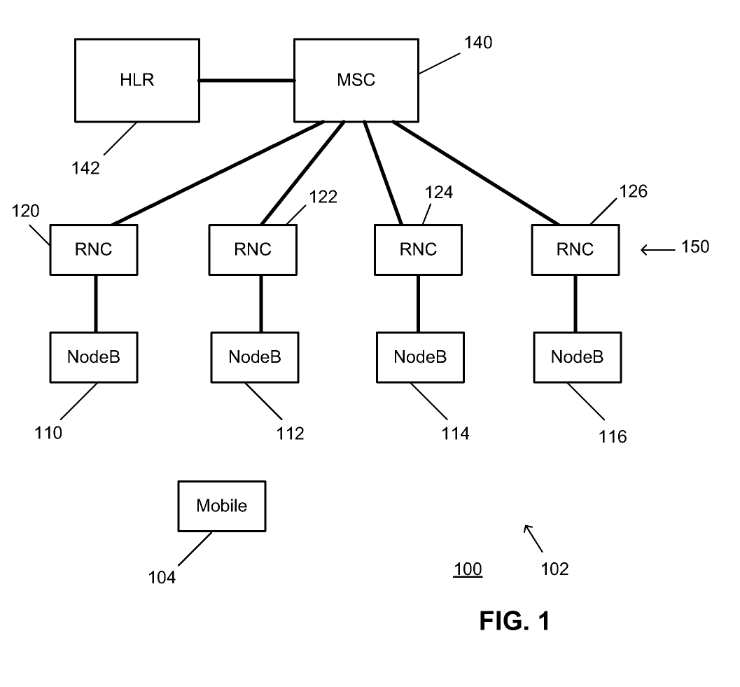

Turning to FIG. 1, an apparatus 100 in one example comprises a communication network 102 and a mobile device 104. The communication network 102 in one example comprises a wireless communication network operated by a service provider, such as a cellular or mobile data network, 3G or 4G network (3rd Generation Partnership Project), Wi-Fi network, Wi-Max network, Institute of Electrical and Electronics Engineers' (IEEE) 802.11 standard compatible network, or other networks as will be understood by those skilled in the art.

The communication network 102 in one example comprises a plurality of network elements, such as base stations 110, 112, 114, and 116 coupled to respective radio network controllers (RNCs) 120, 122, 124, and 126, a mobile switching center (MSC) 140, and a home location register (HLR) 142. While only a single base station is shown coupled to each RNC, a plurality of base stations may also be coupled to a single RNC to provide a service coverage area. These network elements cooperate to provide a wireless data and/or wireless voice service (“wireless service”). The base stations 110, 112, 114, and 116 in one example comprise wireless access points configured to provide a wireless interface or “air interface” for the communication network 102 to the mobile device 104.

In the implementation shown in FIG. 1, the communication network 102 is a Universal Mobile Telecommunications System (UMTS) network and the base stations 110, 112, 114, and 116 comprise Node-Bs. In another implementation where the communication network 102 is a long term evolution (LTE) network, the base stations 110, 112, 114, and 116 comprise enhanced Node-Bs (eNode-Bs) and the corresponding radio network controllers are omitted, as will be appreciated by those skilled in the art.

The mobile device 104 in one example comprises a mobile phone, smart phone, personal digital assistant, transponder, or other electronic device capable of wireless communication. The mobile device 104 is configured to register with the communication network 102 and to perform handovers as part of the wireless service. In a further example, the mobile device 104 is configured to create measurement reports, as described herein. The MSC 140 provides access to a core network (not shown) of the communication network 102. The HLR 142 stores user profiles for subscribers to the wireless service.

The communication network 102 further comprises a handover manager component 150. The handover manager component 150 is configured to compare locations and timestamps for the mobile device 104, as described herein. In the implementation of FIG. 1, the RNCs 120, 122, 124, and 126 may alternately perform the role of the handover manager component 150 for the mobile device 104. For Automatic Neighbor Relation (ANR) procedures (described in 3GPP TS 25.484), a radio network controller may act as a receiving RNC or a base RNC. In one example, a base RNC provides the functionality of the handover manager component 150. In alternative implementations of the communication network 102, an enhanced Node-B, application server, or other network element may perform the role of the handover manager component 150, as will be appreciated by those skilled in the art.

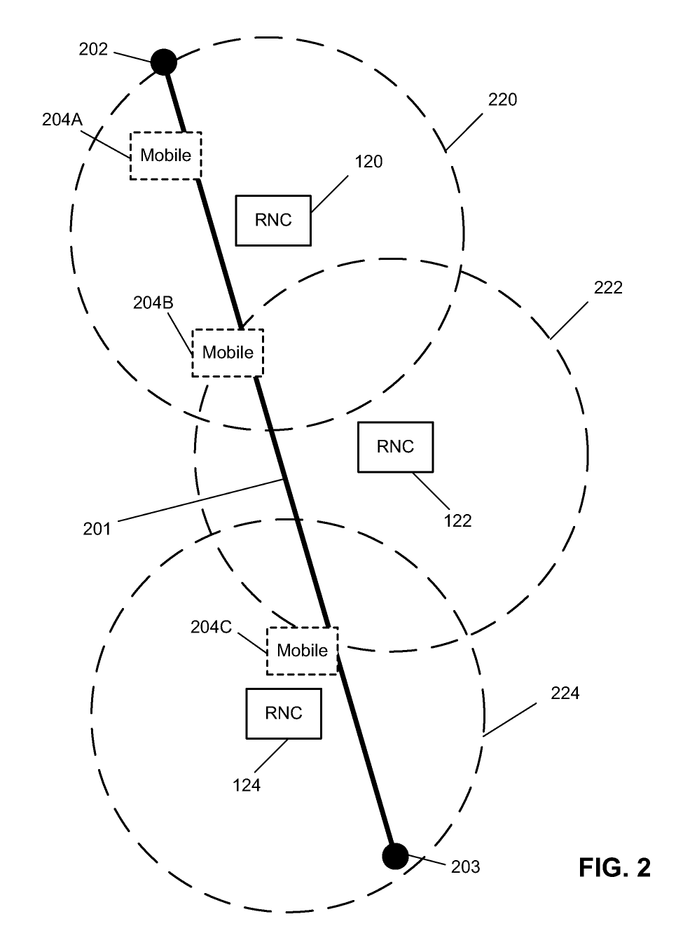

An illustrative description of operation of the apparatus 100 is presented, for explanatory purposes. Turning to FIG. 2, the RNCs 120, 122, and 124 provide service coverage areas 220, 222, and 224, respectively. When registered with the communication network 102, the RNCs 120, 122, and 124 cooperate to perform a handover of the mobile device 104 from a current network element to a next (e.g., target) network element in order to maintain its connectivity. While the current and target network elements are generally referred to herein as Node Bs or RNCs, the network elements may be a base station, Node B, RNC, eNode-B, other network element, or a combination thereof and may depend on the implementation of the communication network 102. When the mobile device 104 moves at a high rate of speed, the frequency of handovers may increase significantly. Each handover requires network resources and processing time to determine the target network element that will accept the mobile device. This determination is often based on Automatic Neighbor Relation procedures. However, ANR procedures are reactive in nature, i.e., they occur when signal quality of the air interface to the mobile device is already diminishing. When traveling at a high rate of speed, the determination of the target network element may not occur before the communication link is dropped.

Referring to FIG. 2, a transportation route 201 is shown as a high-speed rail line with stop points (e.g., stations or terminals) 202 and 203. A user (not shown) of the mobile device 104 has boarded a high-speed train and departed the station 202, headed towards station 203. A first handover for the mobile device 104 occurs near location 204A at a first time, as the mobile device 104 enters the service coverage area 220. A second handover for the mobile device 104 occurs near location 204B at a second time, as the mobile device 104 enters the service coverage area 222.

The RNC 122, acting as the handover manager component 150, in one example is configured to detect the occurrence of the handovers. Upon the handover, the handover manager component 150 compares a location and timestamp for the first and second handovers to determine an anticipated path for the mobile device 104. The location and timestamp for a handover to be compared, referred to herein as location/timestamp data, in one example are stored and/or communicated together as a single data structure or message. In another example, the location and timestamp of the location/timestamp data are stored and/or communicated separately, such as separate variables, parameters, messages, or database entries. Other formats for the location/timestamp data will be apparent to those skilled in the art. The location of the handovers may be determined by geographical coordinates of the RNCs, Node-Bs, or service coverage areas involved with the handover, triangulation data associated with the mobile device 104, or GPS information received from the mobile device 104. The handover manager component 150 performs a differential calculation to determine an anticipated path for the mobile device 104. The anticipated path in one example comprises a direction and speed for the mobile device 104.

While reference is made herein to locations and timestamps for handovers, other messages and/or procedures, either alone or in combination, that provide a location and timestamp for the mobile device 104 may also be used by the handover manager component 150, as will be apparent to those skilled in the art. For example, when a receiving RNC receives a measurement report from the mobile device 104, such as an ANR report (described in 3GPP TS 25.484), the receiving RNC may forward the measurement report to the base RNC. If the base RNC is acting as the handover manager component 150, it may then use a location and timestamp for the measurement report analogously to the location and timestamp of a handover. The location and timestamp for a measurement report may be used instead of or in addition to the locations and timestamps of handovers. The location and timestamp may be extracted from the measurement report or determined through employment of the measurement report by the handover manager component 150. In another example, the receiving RNC extracts or determines the location and timestamp and sends them to the base RNC.

In one example, the handover manager component 150 compares the location/timestamp data of the mobile device 104 with known locations and service coverage areas of adjacent RNCs. The handover manager component 150 thus anticipates a future or subsequent handover, for example, to the RNC 124 and sends a notification to the RNC 124 and/or the base station 114. The notification in one example is sent in advance of the typical handover procedures associated with either low signal quality at a current RNC or a higher signal quality from an adjacent RNC. This provides more time for the RNC 124 and/or base station 114 to reserve resources and execute procedures for the handover of the mobile device 104 at location 204C, as will be appreciated by those skilled in the art.

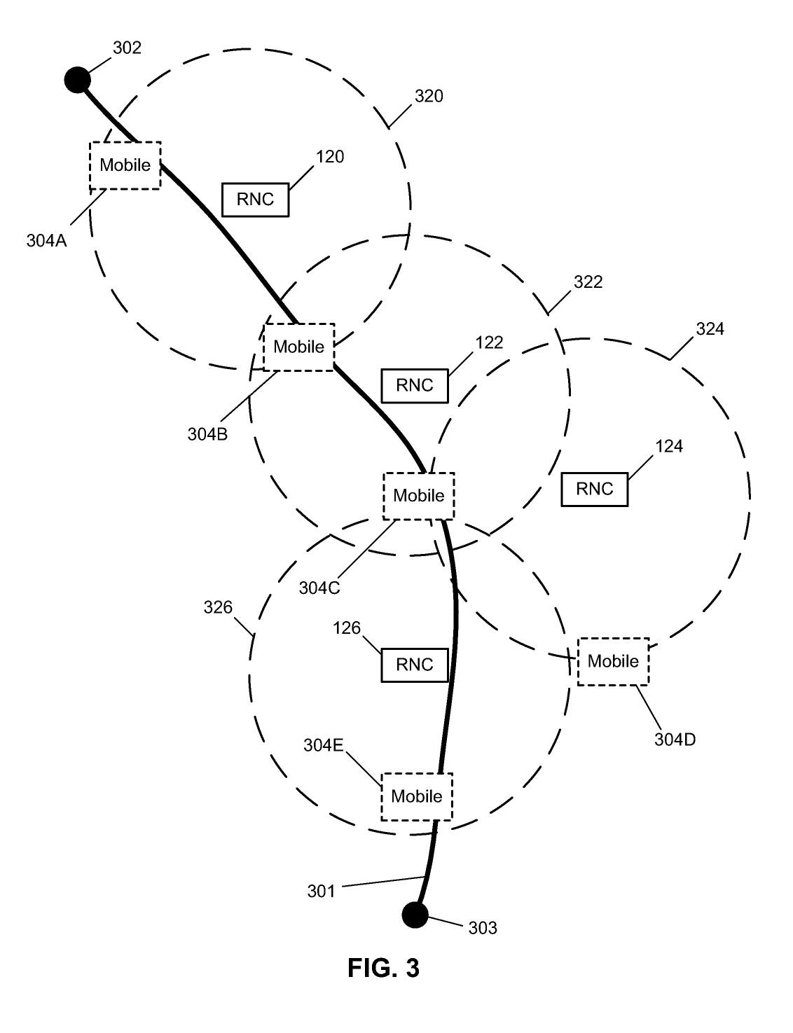

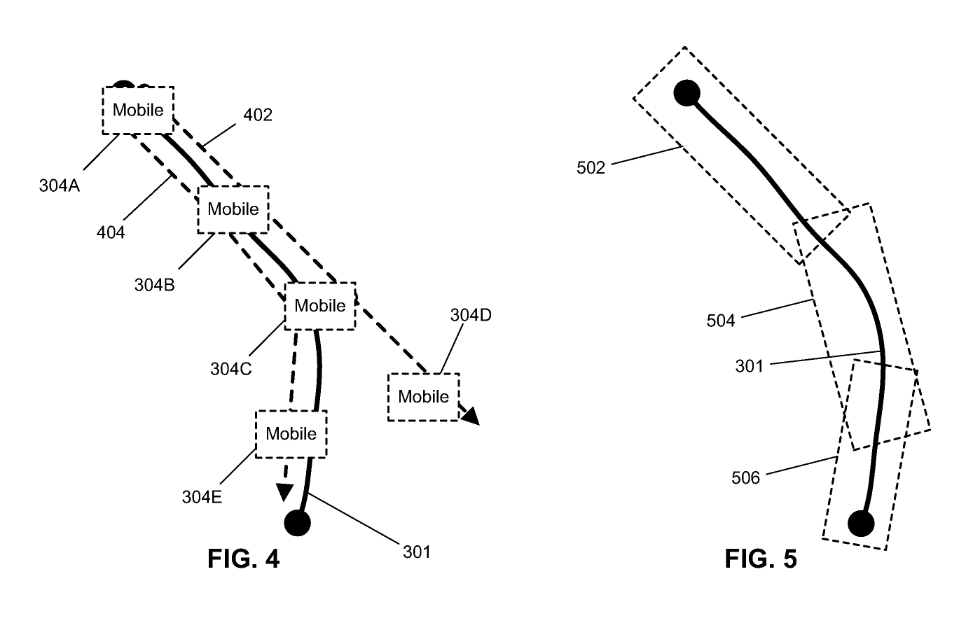

Turning to FIGS. 3 and 4, a transportation route 301 is shown as a high-speed rail route with terminals 302 and 303. RNCs 120, 122, 124, and 126 provide service coverage areas 320, 322, 324, and 326 in the vicinity of the route 301. Where the user has boarded the high-speed train and departed the station 302 towards station 303, handover locations 304A, 304B, and 304C suggest an anticipated path 402 (FIG. 4) that is straight and continues through the service coverage area 324 of RNC 124 to location 304D. However, the curved path of the route 301 makes this anticipated path 402 inaccurate.

Advantageously, the handover manager component 150 is configured to compare the handover locations 304A, 304B, and 304C of the mobile device 104 to a geographical profile for determination of the anticipated path. The geographical profile comprises at least one known transportation route, such as the high-speed rail route 301, and may also include roadways or mass-transit routes that follow a consistent path. The geographical profile in one example is a local geographical profile relative to the service coverage area of the communication network 102. In one example, the geographical profile comprises locations for network elements and/or service coverage areas of the communication network 102. Based on the comparison of the handover locations 304A, 304B, and 304C and/or the anticipated path 402 with the route 301, the handover manager component 150 determines that mobile device 104 is following the anticipated path 404 towards location 304E. The handover manager component 150 in one example selects and employs the anticipated path 404 along the known transportation route to send a notification to the RNC 126 before the mobile device 104 begins a handover near location 304C. The RNC 126 can thus begin resource reservation and processing for the handover. Additionally, the RNC 126 may select a sector for the mobile device 104 based on traffic or network load in advance of the handover.

Comparisons of the location/timestamp data and transportation routes can be made based on location, speed, direction, departure time, arrival time, or other information associated with either the mobile device or a train on a high-speed rail route. For example, the handover manager component 150 may compare a known departure time and route for a high-speed train with the handovers of the mobile device 104. In a further example, the local geographical profile may be updated with real-time or near real-time location/timestamp data for the high-speed train. Location/timestamp data or other information for the high-speed train may be pushed to or requested by the handover manager component 150. The location/timestamp data or other information may be provided by a rail car operator. In one example, a rail car operator may track specific trains or specific cargo equipped with a transponder.

In another example, the prior history of the user of the mobile device 104 may be evaluated, such as a regular commute. This information may be stored in a user profile within the home location register 142. In yet another example, the user may provide an indication to the service provider before using the route 301. Additionally, the handover manager component 150 may store and use history or location/timestamp data from previous handovers of other users and mobile devices to determine the anticipated path and/or update the local geographical profile. For example, the handover manager component 150 may determine the anticipated path based on a proximity of the plurality of previous handovers to the known transportation route.

The handover manager component 150 may be configured to determine the anticipated path after two handovers, three handovers, or more and this number may be configurable by the service provider or adjusted based on network load, available processing resources for the determination, or other factors. In another example, the handover manager component 150 evaluates the speed of the mobile device 104 before determining the anticipated path. For example, if the mobile device's speed is less than a threshold (e.g., 80 or 120 miles per hour) then it does not perform the determination of the anticipated path. The threshold may be high enough to exclude calculations for normal automobile traffic. The threshold may also be configurable by the service provider or adjusted based on the above-mentioned factors.

When performing the comparison of the location/timestamp data to the transportation route, the handover manager component 150 may allow for variation in the location of the mobile device. This allows for acceptable levels of inaccuracy in the reporting of the mobile device's position. As is known in the art, accuracy may be within several feet or several hundred yards, depending on which positioning technology is used. In one example, the handover manager component 150 uses a best-fit line for the location/timestamp data.

In another example, the local geographical profile comprises an approximation of the transportation route 301. Turning to FIG. 5, the rail route 301 is shown bounded by boxes 502, 504, and 506. The handover manager component 150 may consider any location within the boxes 502, 504, and 506 to be along the rail route. The use of boxes, polygons, or other geometric shapes, or other approximation techniques (e.g., best-fit line) allows for simpler calculations for comparison of the location/timestamp data with the known transportation routes and improved evaluation of the mobile device's proximity to the known transportation route.

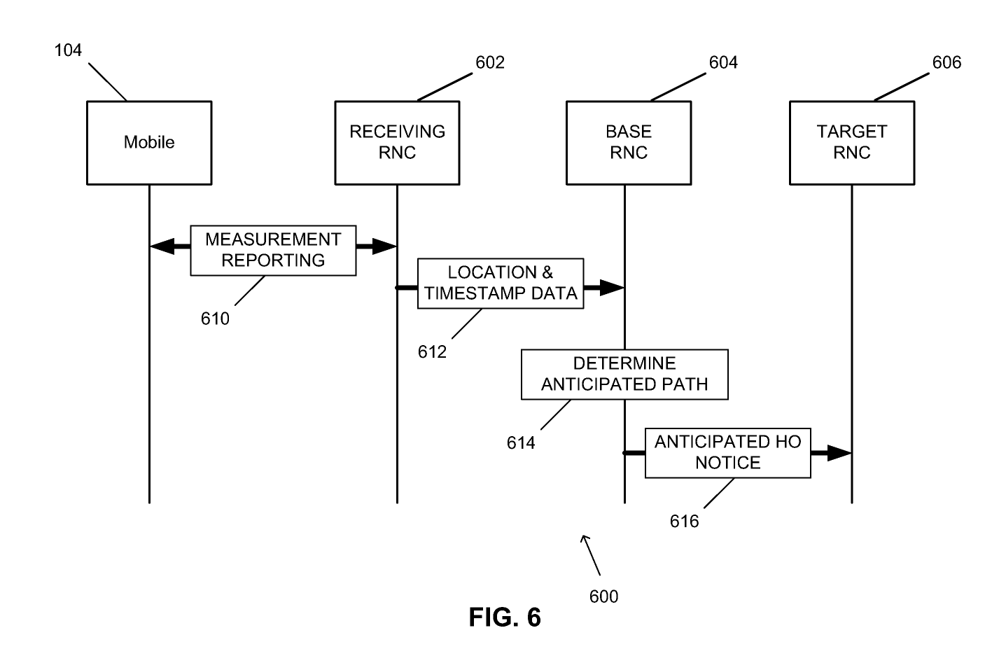

Turning to FIG. 6, a message flow 600 illustrates messaging between the mobile device 104 and RNCs 602, 604, and 606 acting as receiving, base, and target RNCs, respectively. At STEP 610, the mobile device 104 performs measurement reporting for signal strength with a receiving RNC 602. In one example, this measurement reporting is part of the Automatic Neighbor Relation (ANR) procedures. The RNC 602 receives the report and uses an identifier within the report that identifies the base RNC 604 currently serving the mobile device 104.

The receiving RNC 602 sends (STEP 612) location and timestamp data associated with the mobile device and/or measurement report to the base RNC 604. In one example, the RNC 602 uses Radio Network Subsystem Application Part (RNSAP) signaling to send the location/timestamp data, described in 3GPP specification TS 25.423. The base RNC 604 employs the location/timestamp data, along with location/timestamp data for previous handovers or measurement reports, to determine (STEP 614) the anticipated path of the mobile device 104. Upon determination of the anticipated path, the base RNC 604 sends (STEP 616) a notification message to the target RNC 606. The notification message in one example comprises information that allows the target RNC 606 to reserve resources for an anticipated handover for the mobile device 104. This information may comprise an estimated handover time, identifiers for the mobile device 104, or a list of resources that may be needed to accommodate the handover.

While a single notification message may be sent to the target RNC, the base RNC may also create a handover plan for the mobile device 104 based on the anticipated path. The handover plan in one example comprises a sequence of a plurality of RNCs to which the mobile device 104 is likely to be handed over. The handover plan may also comprise estimated handover times for one or more of the RNCs in the sequence. The handover plan may comprise single RNCs along the anticipated path or a cluster of possible RNCs that could receive the mobile device 104.

The base RNC may send a notification to one or more of the RNCs in the sequence. The number of RNCs that receive the notice may be configurable by the service provider, based on the speed of the mobile device 104, or adjusted based on network load, available processing resources for the determination, or other factors. For example, where the handover plan comprises seven RNCs that are located along a high-speed rail line, the current base RNC may send a notice to the next three RNCs in the sequence. The base RNC may also send the entire handover plan to one or more of the RNCs, the mobile device 104, or the HLR 142 for later access by the RNCs. The RNCs, mobile device 104, or the HLR 142 may maintain a history of locations and timestamps for the mobile device 104 for later access by the RNCs. Location/timestamp data and history may also be stored by a separate network component.

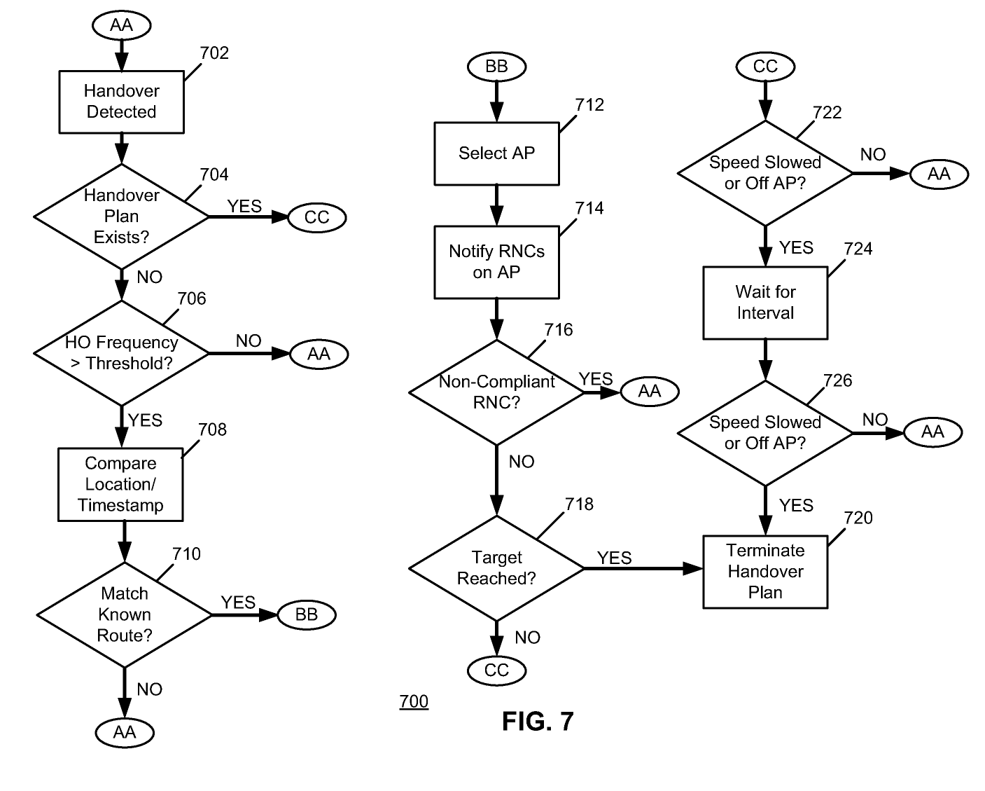

Turning to FIG. 7, a process flow 700 shows one implementation of steps performed by the handover manager component (HMC) 150, such as the base RNC. Beginning at AA, the HMC 150 waits for detection (STEP 702) of a handover, receipt of a measurement report, or other messages or events that indicate a location and timestamp is available. The HMC 150 then determines (STEP 704) whether a handover plan already exists for the mobile device 104. If the handover plan exists, the HMC 150 proceeds to CC for updating or maintaining the handover plan. Without a handover plan, the HMC 150 in one example determines (STEP 706) whether the mobile device 104 is traveling at a speed over a threshold. This determination may be made based on a high frequency of recent handovers over a threshold or based on past and/or current location information for the mobile device 104. If either threshold has not been met or exceeded, the HMC 150 returns to AA.

If the threshold has been met or exceeded, the HMC 150 compares (STEP 708) the location/timestamp data with the local geographical profile. If the location/timestamp data do not match (STEP 710) a known transportation route, the HMC 150 returns to AA. If the data does match (STEP 710) a known route, the HMC 150 proceeds to BB and selects (STEP 712) the anticipated path that corresponds to the known transportation route.

The HMC 150 sends (STEP 714) a notification to one or more of the RNCs and/or base stations on the anticipated path. If a non-compliant RNC or base station is on the anticipated path, it may be skipped over for notifications. Once the target RNC has been reached, the HMC 150 terminates (STEP 720) the handover plan. If additional RNCs remain in the handover plan, the HMC 150 proceeds to CC for updating or maintaining the handover plan.

At CC, the HMC 150 determines whether the mobile device 104 has reduced its speed or stopped. For example, if the transportation route has restricted and/or reduced speed zones, stations and/or terminals for stops, or if the mobile device has slowed for other reasons such as traffic, delays, maintenance, etc. If the mobile device 104 maintains (STEP 722) the anticipated path, the HMC 150 continues to AA. The HMC 150 in one example is configured to anticipate station stops or reduced speed zones when creating the handover plan.

If the mobile device 104 has slowed (step 722) or moved in a direction inconsistent with the anticipated path, the HMC 150 waits (STEP 724) for a timed interval. The duration of the interval may be configurable by the service provider, based on the previous or reduced speed of the mobile device 104, or adjusted based on network load, available processing resources for the determination, or other factors. The HMC 150 determines (STEP 726) whether the mobile device 104 is still slowed or has not resumed an acceptable speed along the anticipated path, and if so terminates (STEP 720) the handover plan. If the mobile device 104 has resumed, the HMC 150 proceeds to AA. Where the handover plan is terminated or modified (e.g., due to a delay and change in estimated arrival time), the HMC 150 in one example sends an update message to the RNCs along the anticipated path. This allows the subsequent RNCs to alter their resource allocation or suspend the handover, for example, to free resources that were previously reserved for the mobile device 104.

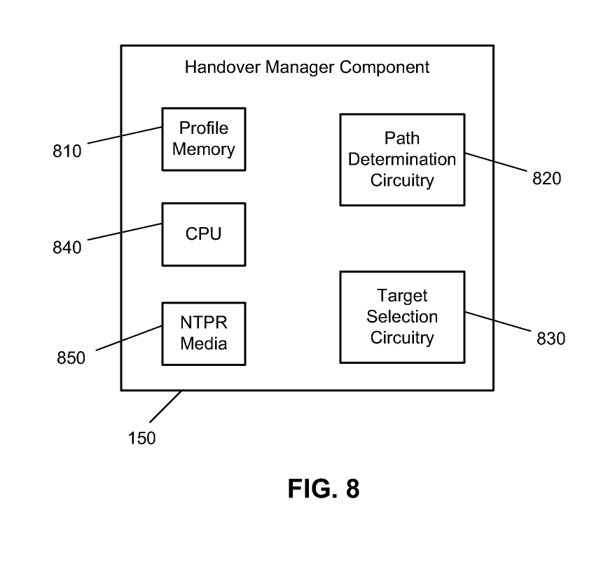

Turning to FIG. 8, one implementation of the handover manager component 150 is shown. The handover manager component 150 in one example comprises one or more components, such as a profile memory 810, path determination circuitry 820, target selection circuitry 830, a processor (CPU) 840, and an instance of a non-transitory processor-readable (NTPR) media 850, as described herein. The profile memory 810 is configured to store at least one geographical profile and may also comprise an instance of a non-transitory processor-readable media. The at least one geographical profile may comprise at least one known transportation route and may also comprise locations for network elements and/or service coverage areas of the communication network 102, as described above.

The path determination circuitry 820 is configured to determine an anticipated path for a mobile device based on data from the profile memory. For example, the path determination circuitry 820 is configured to compare location and timestamp data for the mobile device with data from the profile memory to determine the anticipated path. The path determination circuitry 820 may be configured to perform one or more steps of FIG. 7, such as steps 708, 710, and/or 712.

The target selection circuitry 830 is configured to select a target network element of the communication network for a handover based on data from the path determination circuitry. The target selection circuitry 830 may be configured to select the target network element as a base station, Node B, enhanced Node B, radio network controller, or other network element, depending on the configuration of the communication network 102. The target selection circuitry 830 may be configured to perform one or more steps of FIG. 7, such as steps 714, 716, 718, 720, 722, 724, and/or 726.

The processor 840 in one example is configured to perform any of the steps of FIG. 7. The processor 840 may perform these steps alone or in combination with the profile memory 810, the path determination circuitry 820, and/or the target selection circuitry 830 in various implementations. Instructions for the processor 840 in one example are stored in the NTPR media 850. In alternate implementations of the handover manager component 150, the processor 840 may be omitted and the steps of FIG. 7, along with the other functionality described above, may be performed by the remaining components. While the path determination circuitry 820 and target selection circuitry 830 are described as “circuitry,” they may be implemented by dedicated circuits, the processor 840 with suitable instructions, or a combination thereof, as will be appreciated by those skilled in the art.

The NTPR media 850 and profile memory 810 may be implemented as a single memory device, or as a plurality of separate memory devices. In one example, the profile memory 810 is remotely located from the other components of the handover manager component 150.

The apparatus 100 in one example comprises a plurality of components such as one or more of electronic components, hardware components, and computer software components. A number of such components can be combined or divided in the apparatus 100. An example component of the apparatus 100 employs and/or comprises a set and/or series of computer instructions written in or implemented with any of a number of programming languages, as will be appreciated by those skilled in the art.

The apparatus 100 in one example employs one or more non-transitory processor-readable media. The non-transitory processor-readable media store software, firmware and/or assembly language for performing one or more portions of one or more implementations of the invention. Examples of a non-transitory processor-readable media for the apparatus 100 comprise the profile memory 810 and the non-transitory processor-readable media 850 of the handover manager component 150. The non-transitory processor-readable media for the apparatus 100 in one example comprise one or more of a magnetic, electrical, optical, biological, and atomic data storage medium. For example, the non-transitory processor-readable media comprise floppy disks, magnetic tapes, CD-ROMs, DVD-ROMs, hard disk drives, and electronic memory.

The steps or operations described herein are just for example. There may be many variations to these steps or operations without departing from the spirit of the invention. For instance, the steps may be performed in a differing order, or steps may be added, deleted, or modified.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. An apparatus, comprising:
a handover manager component for a communication network;
wherein the handover manager component is configured to determine a target network element for a handover for a mobile device through employment of an anticipated path of the mobile device and a local geographical profile.

2. The apparatus of claim 1, wherein the local geographical profile comprises one or more of a known transportation route, locations of one or more network elements of the communication network, and locations of one or more service coverage areas of the communication network.

3. The apparatus of claim 2, wherein the known transportation route comprises a high-speed railway, roadway, or mass-transit route.

4. The apparatus of claim 2, wherein the handover manager component is configured to determine the anticipated path based on location and timestamp data for a plurality of previous handovers in the communication network.

5. The apparatus of claim 4, wherein the plurality of previous handovers comprise handovers for a plurality of mobile devices served by the communication network.

6. The apparatus of claim 4, wherein the handover manager component is configured to determine the anticipated path based on a proximity of the plurality of previous handovers to the known transportation route.

7. The apparatus of claim 6, wherein the anticipated path comprises stop points and/or reduced speed zones for the known transportation route.

8. The apparatus of claim 4, wherein the handover manager component is configured to store and compare the location and timestamp data for respective ones of the plurality of previous handovers.

9. The apparatus of claim 8, wherein the handover manager component is configured to determine an estimated handover time to the target network element for the mobile device based on a time differential between respective ones of the plurality of previous handovers.

10. The apparatus of claim 4, wherein the handover manager component is configured to create a handover plan with a plurality of sequential target network elements of the communication network;
wherein the handover manager component sends the handover plan to a subsequent target network element.

11. The apparatus of claim 10, wherein the handover manager component creates the handover plan when an estimated speed of the mobile device is over a threshold.

12. The apparatus of claim 2, wherein the handover manager component is configured to send a notification of an anticipated handover to the target network element to reserve resources of the target network element for the handover.

13. The apparatus of claim 12, wherein the handover manager component is configured to send an update message to the target network element upon a change in the anticipated path of the mobile device.

14. A method, comprising the steps of:
comparing at least first and second location and timestamp data to create an anticipated path for a mobile device served by a communication network;
comparing the anticipated path to a local geographical profile that comprises at least one known transportation route;
if the anticipated path matches one of the at least one known transportation routes, sending a notification of an anticipated handover to one or more network elements of the communication network that are located along the one known transportation route.

15. The method of claim 14, wherein the step of comparing the at least first and second location and timestamp data comprises:
performing a differential calculation to determine a speed and direction of the mobile device for the anticipated path.

16. The method of claim 15, wherein the step of comparing the anticipated path to the local geographical profile comprises the step of:
comparing the anticipated path to the local geographical profile only if the speed of the mobile device exceeds a threshold.

17. The method of claim 14, further comprising the step of:
creating a handover plan based on the anticipated path of the mobile device and the one known transportation route;
sending the handover plan to the one or more network elements of the communication network that are located along the one known transportation route.

18. The method of claim 14, further comprising the step of:
sending an update message to the one or more network elements upon a change in the anticipated path for the mobile device.

19. The method of claim 18, wherein the step of sending the update message comprises:
sending a suspend message for the anticipated handover.

20. The method of claim 18, wherein the step of sending the update message comprises:
sending a free resource message for the anticipated handover.

21. An apparatus, comprising:
a handover manager component for a communication network;
wherein the handover manager component comprises:
a profile memory configured to store at least one geographical profile;
path determination circuitry configured to determine an anticipated path for a mobile device based on data from the profile memory; and
target selection circuitry configured to select a target network element of the communication network for a handover based on data from the path determination circuitry.

22. The apparatus of claim 21, wherein the profile memory is configured to store at least one geographical profile that comprises at least one known transportation route.

23. The apparatus of claim 21, wherein the profile memory is configured to store at least one geographical profile that comprises a location for at least one network element of the communication network.

24. The apparatus of claim 21, wherein the path determination circuitry is configured to compare location and timestamp data for the mobile device with data from the profile memory to determine the anticipated path.

25. The apparatus of claim 21, wherein the target selection circuitry is configured to select the target network element as one of a base station, Node B, enhanced Node B, or radio network controller of the communication network.
